(19) United States
(12) Patent Application Publication
(10) Pub. No.: US 2022/0383089 A1
(43) Pub. Date: Dec. 1, 2022

(54) INTELLIGENT MEETING HOSTING USING ARTIFICIAL INTELLIGENCE ALGORITHMS

(71) Applicant: Avaya Management L.P., Durham, NC (US)

(72) Inventors: Pragati Dhumal, Pune (IN); Navanath Navaskar, Pune (IN); Tanvi Sharma, Pune (IN)

(21) Appl. No.: 17/329,567

(22) Filed: May 25, 2021

(51) Int. Cl. G06N 3/08; G06N 3/04; G10L 15/22; G10L 15/18; G06K 9/00; G06T 7/20

(52) U.S. Cl. CPC G06N 3/08; G06N 3/0472; G10L 15/22; G10L 15/1815; G06K 9/00711; G06K 9/00335; G06T 7/20; G06Q 10/10

(57) ABSTRACT

A device may analyze input data received at the device. The device may extract contextual information associated with the input data based on the analyzing. The device may provide at least a portion of the contextual information to a machine learning network. The device may receive an output from the machine learning network in response to the machine learning network processing at least the portion of the contextual information. The device may output a notification associated with enabling content sharing based on the output from the machine learning network. The input data may include audio data, and analyzing the input data may include applying speech processing operations, natural language processing operations, or both to the audio data. The input data may include video data, and analyzing the input data may include applying gesture recognition operations, object tracking operations, or both to the video data.

### FIELD

The present disclosure relates to systems and methods for alerting a user to share content during a meeting.

### BACKGROUND

Some devices may support communications applications capable of various communication modalities such as, for example, audio, video, and text communications. For example, some communications applications may support conference meetings (e.g., online meetings) in which attendees may communicate via audio, video, and/or text. In some cases, for example, some communications applications may support content sharing (e.g., screen sharing) for presenting content to attendees of a meeting.

### BRIEF SUMMARY

The described techniques relate to improved methods, systems, devices, and apparatuses that support an artificial intelligence meeting assistant. Generally, the described techniques provide for a facility (e.g., using artificial intelligence (AI) algorithms) to alert or notify a user if the user forgets to share content when presenting during a virtual meeting. In some aspects, the techniques provide for notifying the user if sharing inadvertently stops (e.g., due to technical issues) during the virtual meeting.

A method, device, and system are provided that include: analyzing input data received at a device; extracting contextual information associated with the input data based on the analyzing; providing at least a portion of the contextual information to a machine learning network; receiving an output from the machine learning network in response to the machine learning network processing at least the portion of the contextual information; and outputting a notification associated with enabling content sharing based on the output from the machine learning network.

In some examples of the method, device, and system described herein, the input data may include audio data, and analyzing the input data may include applying one or more speech processing operations, one or more natural language processing operations, or both to the audio data. In some other aspects, the input data may include video data, and analyzing the input data may include applying one or more gesture recognition operations, one or more object tracking operations, or both to the video data. In some aspects, the output by the machine learning network may include a probability score and/or a confidence score associated with a determination made by the machine learning network with respect to sharing content associated with the input data. In some examples, the notification may be associated with enabling audio communications, enabling video communications, or both.

These and other needs are addressed by the various embodiments and configurations of the present disclosure. The present disclosure can provide a number of advantages depending on the particular configuration. These and other advantages will be apparent from the disclosure contained herein.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “analyze,” “process,” “execute,” “manage,” “calculate,” and “compute,” and variations thereof, as used herein, are used interchangeably and include any type of methodology, process, mathematical operation or technique. The term “manage” includes any one or more of the terms determine, recommend, configure, organize, show (e.g., display), hide, update, revise, edit, and delete, and includes other means of implementing actions (including variations thereof).

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 illustrates an example of a system that supports intelligent meeting hosting using AI algorithms in accordance with aspects of the present disclosure.

FIG. 2 illustrates an example of a system that supports intelligent meeting hosting using AI algorithms in accordance with aspects of the present disclosure.

FIG. 3 illustrates an example of a communications application that supports intelligent meeting hosting using AI algorithms in accordance with aspects of the present disclosure.

FIG. 4 illustrates an example of a user interface that supports intelligent meeting hosting using AI algorithms in accordance with aspects of the present disclosure.

FIG. 5 illustrates an example of a user interface that supports intelligent meeting hosting using AI algorithms in accordance with aspects of the present disclosure.

FIG. 6 illustrates an example of a process flow that supports intelligent meeting hosting using AI algorithms in accordance with aspects of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides illustrative embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the illustrative embodiments will provide those skilled in the art with an enabling description for implementing an illustrative embodiment. It should however be appreciated that the present disclosure may be practiced in a variety of ways beyond the specific detail set forth herein.

Some devices may support communications applications for conducting online meetings (also referred to herein as a virtual meetings) between multiple users. Some communications applications, for example, may support content sharing (e.g., screen sharing) by a user (e.g., a presenter) during a meeting. In some cases, however, a user who is presenting on a topic during a meeting may forget to display content (e.g., activate content sharing) during the presentation.

In an example, other users attending the meeting may be unaware that the presenter intended to display related content during the presentation, and the users may refrain from alerting the presenter that no content is being displayed. During the presentation, however, a user may realize that the presenter had intended to display the related content. Accordingly, in the middle of the presentation, the attendee may inquire (e.g., via audio communications, an instant message via the communications application, etc.) whether the presenter intended to display content. In some cases, the presenter may activate content sharing and restart the presentation, resulting in an inefficient meeting.

In some other cases, the presenter may activate content sharing at the start of a presentation, but technical issues (e.g., an application error) may terminate the content sharing such that the content is no longer displayed to other users. In an example, the presenter may be unaware that the content is no longer being displayed, and the presenter may remain unaware of the problem until an attendee notifies the presenter of the problem. Alternatively, in some cases, the presenter may have to continuously monitor and verify whether the content is being displayed, which may be distracting and inconvenient to the presenter.

According to example aspects of the present disclosure, a device supportive of intelligent meeting hosting using AI algorithms is described herein. For example, machine learning techniques described herein may support automatically and intelligently analyzing input data received at a user device to verify whether a user (e.g., a meeting presenter) intends to share content (e.g., activate content sharing) during a meeting hosted by a communications application (e.g., a meeting application for conducting virtual meetings or online meetings). The input data may include audio data associated with a user, such as oral statements by the user. In some examples, the input data may include text data corresponding to the oral statements (e.g., text data generated by natural language processing techniques). In some other aspects, the input data may include text-based communications transmitted by the user over the communications application. In some aspects, the input data may include video data associated with the user (e.g., video streamed over the communications application during the online meeting).

In some aspects, the machine learning techniques (e.g., using various artificial intelligence algorithms) described herein may be implemented and executed by a device to learn and predict, based on the input data (e.g., user statements included in audio data, text data corresponding to the oral statements, user expressions and/or eye movement captured in video data, etc.), whether the user has intended to activate content sharing for presenting content to other users. In some aspects, the machine learning techniques may support analysis of input data during an online meeting conducted via a communications application.

In some examples, content sharing may be inactive at the device (e.g., no content is being shared by the presenter). The device may predict (e.g., using executed artificial intelligence algorithms) that the presenter has intended to share content. The device (e.g., via the communications application) may output a notification associated with the prediction. For example, the device may output a notification (e.g., a warning or alert) to the presenter indicating that no content is currently being shared. In some cases, the notification may include an inquiry or confirmation request asking whether the presenter would like to activate content sharing. In an example, the notification may include a user interface for activating content sharing. In some cases, based on a user input, the device may provide a user interface for selecting content to share.

Examples of the aspects described herein may provide advantages over other communications applications. For example, some the example aspects described herein provide for an increase in user awareness and user convenience when presenting content during an online meeting. In some aspects, the device may support data models (e.g., neural network models) that are tunable according to user parameters, user configurations, and/or user preferences.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

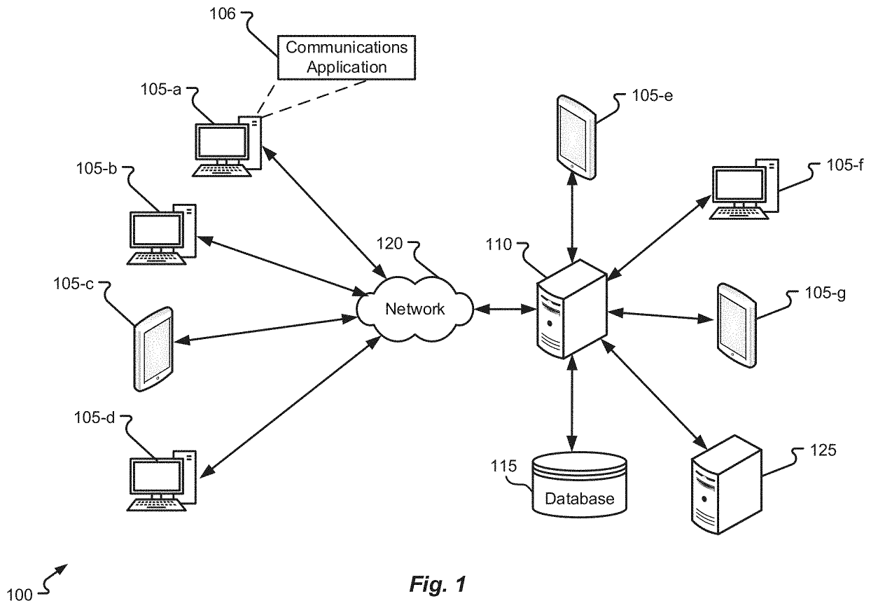

FIG. 1 illustrates an example of a system 100 that supports intelligent meeting hosting using AI algorithms in accordance with aspects of the present disclosure.

The system 100 may include communication devices 105 (e.g., communication device 105-a through communication device 105-g), an application server 110, a database 115, a communication network 120, and one or more other servers 125. The communication network 120 may facilitate machine-to-machine communications between any of the communication device 105 (or multiple communication devices 105), the application server 110, the other servers 125, or one or more databases (e.g., database 115). The communication network 120 may include any type of known communication medium or collection of communication media and may use any type of protocols to transport data between endpoints. The communication network 120 may include wired communications technologies, wireless communications technologies, or any combination thereof.

A communication device 105 may transmit or receive data packets to one or more other devices (e.g., another communication device 105, the application server 110, the other servers 125) via the communication network 120 and/or via the application server 110. For example, the communication device 105-a may communicate (e.g., exchange data packets) with the communication device 105-b via the communications network 120. In another example, the communication device 105-a may communicate with another device (e.g., communication device 105-e, database 115, server 125) via the communications network 120 and the application server 110.

Non-limiting examples of the communication devices 105 may include, for example, personal computing devices or mobile computing devices (e.g., laptop computers, mobile phones, smart phones, smart devices, wearable devices, tablets, etc.). In some examples, the communication devices 105 may be operable by or carried by a human user. In some aspects, the communication devices 105 may perform one or more operations autonomously or in combination with an input by the user.

The communication devices 105 may support one or more communications applications 106 (also referred to herein as an integrated communications applications) for communication between the communication devices 105. The communications applications 106, for example, may support integrated audio, video, and text communications between communication devices 105. In some cases, the communications applications 106 may support instant messaging, availability services, and roster management services.

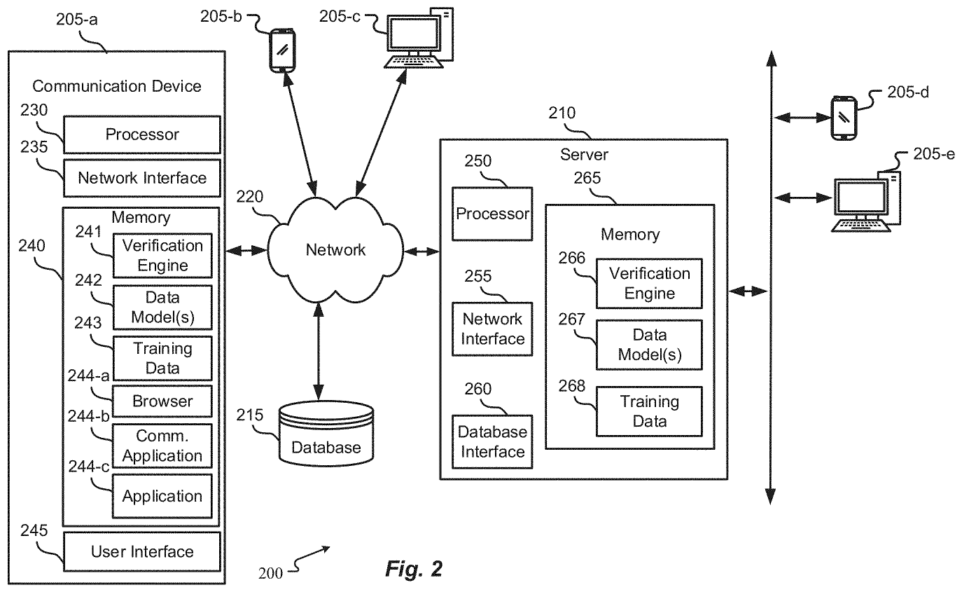

In an example, the application server 110 may be configured to provide application services to the communication devices 105. The application services may include communication services associated with one or more communications applications 106. Example aspects of the communications applications 106 are described herein with reference to FIG. 2.

Wired communications technologies may include, for example, Ethernet-based wired local area network (LAN) connections using physical transmission mediums (e.g., coaxial cable, copper cable/wire, fiber-optic cable, etc.). Wireless communications technologies may include, for example, cellular or cellular data connections and protocols (e.g., digital cellular, personal communications service (PCS), cellular digital packet data (CDPD), general packet radio service (GPRS), enhanced data rates for global system for mobile communications (GSM) evolution (EDGE), code division multiple access (CDMA), single-carrier radio transmission technology (1xRTT), evolution-data optimized (EVDO), high speed packet access (HSPA), universal mobile telecommunications service (UMTS), 3G, long term evolution (LTE), 4G, and/or 5G, etc.), Bluetooth, Bluetooth low energy, Wi-Fi, radio, satellite, infrared connections, and/or ZigBee communication protocols.

The Internet is an example of the communication network 120 that constitutes an Internet Protocol (IP) network consisting of multiple computers, computing networks, and other communication devices located in multiple locations, and components in the communication network 120 (e.g., computers, computing networks, communication devices) may be connected through one or more telephone systems and other means. Other examples of the communication network 120 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 120 may include of any combination of networks or network types. In some aspects, the communication network 120 may include any combination of communication mediums such as coaxial cable, copper cable/wire, fiber-optic cable, or antennas for communicating data (e.g., transmitting/receiving data).

Example aspects of components and functionalities of the communication devices 105, the application server 110, the database 115, and the communication network 120 are provided with reference to FIG. 2.

While the illustrative aspects, embodiments, and/or configurations illustrated herein show the various components of the system 100 collocated, certain components of the system 100 can be located remotely, at distant portions of a distributed network, such as a LAN and/or the Internet, or within a dedicated system. Thus, it should be appreciated, that the components of the system 100 can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

FIG. 2 illustrates an example of a system 200 that supports intelligent meeting hosting using AI algorithms in accordance with aspects of the present disclosure. In some examples, the system 200 may be implemented by aspects of the system 100 described with reference to FIG. 1. The system 200 may include communication devices 205 (e.g., communication device 205-a through communication device 205-e), an application server 210, a database 215, and a communication network 220. The communication devices 205, the application server 210, the database 215, and the communications network 220 may be implemented, for example, by like elements described with reference to FIG. 1.

The communication network 220 may facilitate machine-to-machine communications between any of the communication device 205 (or multiple communication devices 205), the application server 210, and one or more databases (e.g., database 215). The communication network 220 may include any type of known communication medium or collection of communication media and may use any type of protocols to transport messages between endpoints. In some aspects, the communication network 220 may include wired communications technologies, wireless communications technologies, or any combination thereof. In an example, the communication devices 205, and the application server 210 may support communications over the communications network 220 between multiple entities (e.g., users). In some cases, the system 200 may include any number of communication devices 205, and each of the communication devices 205 may be associated with a respective entity.

In various aspects, settings of any of the communication devices 205 or the application server 210 may be configured and modified by any user and/or administrator of the system 200. Settings may include parameters associated with analyzing input data at a communication device 205. The input data may include audio data (e.g., oral statements by the user), text data corresponding to the oral statements, text-based communications by the user, or video data as described herein. Settings may be configured to be personalized for one or more communication devices 205, users of the communication devices 205, and/or other groups of entities, and may be referred to herein as profile settings, user settings, or organization settings. In some aspects, rules and settings may be used in addition to, or instead of, the parameters described herein. In some examples, the rules and/or settings may be personalized by a user and/or administrator for any variable, threshold, user (user profile), communication device 205, entity, or groups thereof.

A communication device 205 (e.g., communication device 205-a) may include a processor 230, a network interface 235, a memory 240, and a user interface 245. In some examples, components of the communication device 205 (e.g., processor 230, network interface 235, memory 240, user interface 245) may communicate over a system bus (e.g., control busses, address busses, data busses) included in the communication device 205. In some cases, the communication device 205 may be referred to as a computing resource.

In some cases, a communication device 205 (e.g., communication device 205-a) may transmit or receive packets to one or more other devices (e.g., another communication device 205, the application server 210, the database 215) via the communication network 220, using the network interface 235. The network interface 235 may include, for example, any combination of network interface cards (NICs), network ports, associated drivers, or the like. Communications between components (e.g., processor 230, memory 240) of the communication device 205 and one or more other devices (e.g., another communication device 205, the database 215) connected to the communication network 220 may, for example, flow through the network interface 235.

The processor 230 may correspond to one or many computer processing devices. For example, the processor 230 may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 240 of the communication device 205). For example, upon executing the instruction sets stored in memory 240, the processor 230 may enable or perform one or more functions of the communication device 205.

The processor 230 may utilize data stored in the memory 240 as a neural network. The neural network may include a machine learning architecture. In some aspects, the neural network may be or include any machine learning network such as, for example, a deep learning network, a convolutional neural network, an artificial neural network (ANN), or the like. Some elements stored in memory 240 may be described as or referred to as instructions or instruction sets, and some functions of the communication device 205 may be implemented using machine learning techniques.

The memory 240 may include one or multiple computer memory devices. The memory 240 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 240, in some examples, may correspond to a computer-readable storage media. In some aspects, the memory 240 may be internal or external to the communication device 205.

The memory 240 may be configured to store instruction sets, neural networks, and other data structures (e.g., depicted herein) in addition to temporarily storing data for the processor 230 to execute various types of routines or functions. For example, the memory 240 may be configured to store program instructions (instruction sets) that are executable by the processor 230 and provide functionality of a verification engine 241 described herein. The memory 240 may also be configured to store data or information that is usable or capable of being called by the instructions stored in memory 240. One example of data that may be stored in memory 240 for use by components thereof is a data model(s) 242 (also referred to herein as a neural network model) and/or training data 243 (also referred to herein as a training data and feedback).

The verification engine 241 may include a single or multiple engines. The communication device 205 (e.g., the verification engine 241) may utilize one or more data models 242 for recognizing and processing information obtained from other communication devices 205, the application server 210, and the database 215. In some aspects, the communication device 205 (e.g., the verification engine 241) may build and/or update one or more data models 242 based on learned information included in the training data 243. In some aspects, the verification engine 241 and the data models 242 may support forward learning based on the training data 243. The verification engine 241 may have access to and use one or more data models 242. For example, the data model(s) 242 may be built and updated by the verification engine 241 based on the training data 243. The data model(s) 242 may be provided in any number of formats or forms. Non-limiting examples of the data model(s) 242 include Decision Trees, Support Vector Machines (SVMs), Nearest Neighbor, and/or Bayesian classifiers.

In some examples, the training data 243 may include communication data (e.g., audio data such as speech inputs, text data corresponding to the speech inputs, inputted text data, video data such as streamed or recorded video, etc.) associated with the communication device 205. In some cases, the communication data may include communication histories (e.g., transmitted communication data) between the communication device 205 and other communication devices 205 (e.g., any of communication device 205-b through communication device 205-e), real-time communication data between the communication device 205 and other communication devices 205, data transmissions between the communication device 205 and the application server 210, etc. In some aspects, communication histories between a communication device 205 (e.g., communication device 205-a) and another communication device 205 (e.g., communication device 205-b) may include communication between a user of the communication device 205 and a user of the other communication device 205. In some aspects, the training data 243 may include outputs (e.g., predictions) by the verification engine 241. In some examples, the training data 243 may include past actions of a user with respect to previous predictions by the verification engine 241.

The verification engine 241 may be configured to analyze data (e.g., audio data, text data, video data, content) provided by any of the communication devices 205 (e.g., communications application 244-b) and/or the application server 210 (e.g., supporting the communications application 244-b). The data may include, for example, historical data (e.g., previously communicated by a communication device 205, previously recorded by the communication device 205) or real-time data.

In some aspects, the verification engine 241 may be configured to analyze data (e.g., audio data, text data, video data, content) provided by any of the communication devices 205 (e.g., communications application 244-b, application 244-c) and/or the application server 210 (e.g., supporting the communications application 244-b and/or the application 244-c).

The verification engine 241 may be configured to receive information from other communication devices 205, and/or the application server 210. The verification engine 241 may be configured to analyze input data (e.g., audio data, video data, text data) received at a communication device 205 in associated with one or more users. For example, the verification engine 241 may extracting contextual information and/or content associated with the input data. In some aspects, the verification engine 241 may determine a probability score and/or confidence score corresponding to sharing content associated with the input data.

In some aspects, the verification engine 241 may build any number of user profiles using automatic processing, using artificial intelligence and/or using input from one or more users associated with the communication devices 205. The user profiles may be associated with, for example, respective entities (users) of different communication devices 205. The verification engine 241 may use automatic processing, artificial intelligence, and/or inputs from one or more users of the communication devices 205 to determine, manage, and/or combine information relevant to a user profile.

The verification engine 241 may update (e.g., continuously, periodically) user profiles based on new information that is relevant to the user profiles. The verification engine 241 may receive new information from any communication device 205, the application server 210, the database 215, etc. Profile information may be organized and classified in various manners. In some aspects, the organization and classification of profile information may be determined by automatic processing, by artificial intelligence and/or by one or more users of the communication devices 205.

The verification engine 241 may store audio profiles (e.g., voice profiles) associated with users of the communication devices 205. In an example, the verification engine 241 may store the audio profiles in the memory 240 (e.g., in a database included in the memory 240), the database 215, and/or memory 265 of the application server 210. The audio profiles may include, for example, speech patterns or speech mannerisms associated with the users.

The verification engine 241 may store video profiles (e.g., image profiles) associated with users of the communication devices 205. In an example, the verification engine 241 may store the video profiles in the memory 240 (e.g., in a database included in the memory 240), the database 215, and/or memory 265 of the application server 210. The video profiles may include, for example, facial recognition features, facial expressions, physical mannerisms, common gestures, or gesture patterns associated with the users.

Data within the database of the memory 240 may be updated, revised, edited, or deleted by the verification engine 241. In some aspects, the verification engine 241 may support continuous, periodic, and/or batch fetching of data (e.g., audio data, text data, video data, content) of users associated with the communication devices 205, the communications applications 244-b, or any combination thereof. The verification engine 241 may fetch or receive the data from the communication devices 205, the application server 210, or any combination thereof.

Information stored in the database included in the memory 240 may include and is not limited to communication information, user information, key words, key physical features (e.g., facial features, mannerisms, gesture patterns), configurations, settings, variables, and properties. Further, information regarding the relevance of different types of content, as well as how to determine relevance (e.g., rules, settings, source(s) of content, rankings of content, location of key words/phrases/physical features, repetition of key words/phrases/physical features, definitions of relevance, etc.) or contextual information associated with content may be stored in the database included in the memory 240.

The verification engine 241 may create, select, and execute processing decisions. Processing decisions may include, for example, notification decisions associated with a communications application 244-b provided at a communication device 205 or the application server 210. In some aspects, processing decisions may include decisions associated with activating content sharing (e.g., based on a user input, automatically based on predictions by a machine learning network), suggesting content to share, or selecting content at a communication device 205.

In some other aspects, the verification engine 241 may create, select, and execute processing operations. The processing operations may include determining contextual information associated with audio content (e.g., speech inputs) and/or text content (e.g., text inputs) at the communication device 205 and/or the communications application 244-b. For example, the processing operations may include natural language processing operations, based on which the verification engine 241 and/or the processor 230 may determine the contextual information.

In an example, the verification engine 241 and/or the processor 230 (e.g., separately, or in combination) may apply one or more natural language processing operations to audio data (e.g., speech inputs) input at the communication device 205 and/or the communications application 244-b. The natural language processing operations may include, for example, linguistic context recognition, word recognition, speech recognition operations (e.g., speech-to-text operations). In some aspects, the verification engine 241 and/or the processor 230 may apply any of the natural language processing techniques to audio data (e.g., speech inputs) input at the communication device 205 and/or the communications application 244-b, thereby generating text data (e.g., a transcript, a partial transcript, a text summary, etc.) corresponding to the audio content.

In another example, the verification engine 241 and/or the processor 230 (e.g., separately, or in combination) may apply gesture recognition operations and/or object tracking operations to the video data (e.g., recorded or streamed video) input at the communication device 205 and/or the communications application 244-b. The gesture recognition operations may include, for example, facial recognition or bodily (e.g., hands, arms) recognition operations. The object tracking operations may include, for example, eye-gaze detection, eye tracking, head movement tracking, etc. In some aspects, the verification engine 241 and/or the processor 230 may apply any of the gesture recognition techniques and/or object tracking techniques to video data input at the communication device 205 and/or the communications application 244-b, thereby generating contextual information corresponding to the video content.

In some aspects, the processing operations may include, for example, content extraction, content analysis, and context analysis. In an example, the verification engine 241 and/or the processor 230 may perform syntactic analysis (e.g., parse, analyze sentence structure, etc.) and/or semantic analysis on text generated by the natural language processing techniques (e.g., text generated by speech recognition operations). In some aspects of syntactic analysis, the verification engine 241 and/or the processor 230 may parse all or portions of the generated text. In an example, based on the syntactic analysis, the verification engine 241 and/or the processor 230 may apply semantic analysis to determine contextual information (e.g., semantics information) associated with the generated text.

In some other aspects, the verification engine 241 and/or the processor 230 may apply content extraction, content analysis, and context analysis (e.g., natural language processing operations, syntactic analysis, semantic analysis) described herein to text content (e.g., text-based communications) input, communicated, or stored by any of the communication device 205, the communications application 244-b, the application server 210. Alternatively, or additionally, the verification engine 241 and/or the processor 230 may apply content extraction, content analysis, and context analysis described herein to any multimedia data (e.g., text, audio, video) communicated, accessed, or stored by any of the communication devices 205, the communications application 244-b, the database 215, and/or the application server 210.

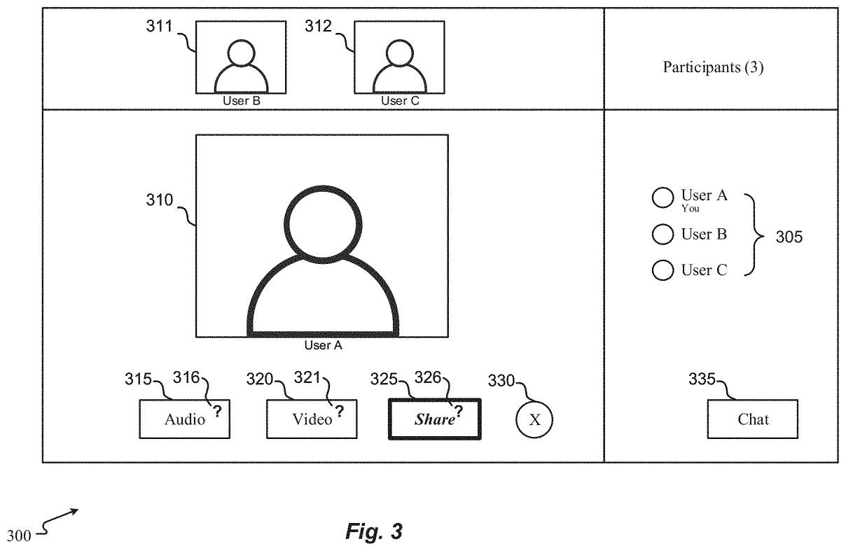

In some examples, the contextual information may include an indication of whether a user (e.g., a presenter) intends to, or has intended to, share content. For example, the contextual information may include an indication of whether the user intends to, or has intended to, activate content sharing using the communications application 244-b. In some aspects, the contextual information may include statements, phrases, and/or key words indicating that the user intends to, or has intended to, activate content sharing. Example statements, phrases, and key words are described herein with reference to FIG. 3. In some other aspects, the contextual information may include gesture meanings, whether a user is actively or passively looking at a display of the communication device 205 (e.g., based on eye-tracking), or whether a user is not looking at the display (e.g., based on eye-tracking).

In some examples, based on the contextual information, the verification engine 241 and/or the processor 230 (e.g., a machine learning network implemented by the verification engine 241 and/or the processor 230) may predict and verify whether the user has intended to activate content sharing for presenting content to other users.

In some examples, the processing decisions may include predicting whether the user intends to, or has intended to, enable audio inputs (e.g., disable a mute function) and/or video inputs (e.g., enable a video feed) at the communications application 244-b. In some other examples, the processing decisions may include predicting an active application, an active window, an active document to share using the communications application 244-b. In some aspects, the verification engine 241 and/or the processor 230 may predict the application, active window, and/or active document based on content associated with therewith.

The processing decisions and/or processing operations described herein may be performed automatically by the verification engine 241, with or without human input.

The communication device 205 may render a presentation (e.g., visually, audibly, using haptic feedback, etc.) of an application 244 (e.g., browser 244-a, communications application 244-b, another application 244-c). In an example, the communication device 205 may render the presentation via the user interface 245. Settings of the user interface 245 may be partially or entirely customizable and may be managed by one or more users, by automatic processing, and/or by artificial intelligence. The user interface 245 may include, for example, a display (e.g., a touchscreen display), an audio output device (e.g., a speaker, a headphone connector), or any combination thereof. In some aspects, the user interface 245 may indicate inputs associated with hardware components (e.g., a keyboard, a keypad, a mouse, a touchpad) integrated with or coupled to the communication device 205.

In some aspects, the applications 244 may be stored on the memory 240. In some cases, the applications 244 may include cloud-based applications or server-based applications (e.g., supported and/or hosted by the application server 210). In an example, the application 244-c may be a desktop application or mobile application associated with an office suite.

In an example, any of the applications 244 (e.g., browser application 244-a, communication application 244-b, application 244-c) may be configured to receive data in an electronic format and present content of data via the user interface 245. For example, the applications 244 may receive data from another communication device 205, the application server 210 via the communications network 220, and the communication device 205 may display the content via the user interface 245.

For example, the communication device 205 may support the transmission and reception of communications (e.g., audio calls, video calls, instant messages, document transmissions) between users via the communications application 244-b. In some cases, the communications application 244-b may be referred to as an integrated communications application. For example, the communications application 244-b may support integrated audio, video, and text communications between communication devices 205. In some aspects, the communications application 244-b may support group communications between three or more users.

In some cases, the communications applications 244-b may support audio calling, video calling, instant messaging (e.g., including text data, audio, video, etc.), availability services (e.g., presence monitoring), and roster management services. In some aspects, the communications application 244-b may be integrated with a VOIP application. In some cases, the communications application 244-b may be a standalone application. In some other aspects, the communications application 244-b may be integrated with another application such as, for example, a social media application.

The communications application 244-b may support content sharing between multiple communication devices 205. Content sharing may include, for example, real-time sharing of content (e.g., screen sharing, document sharing, etc.) between communication devices 205. In some aspects, the communications application 244-b may support (e.g., in combination with the application server 210) the hosting and conducting of online meetings between users of the communication devices 205. The communications application 244-b may include example aspects of the communications application 106 described with reference to FIG. 1.

The database 215 may include a relational database, a centralized database, a distributed database, an operational database, a hierarchical database, a network database, an object-oriented database, a graph database, a NoSQL (non-relational) database, etc. In some aspects, the database 215 may store and provide access to, for example, any of the stored data described herein.

The application server 210 may include a processor 250, a network interface 255, database interface instructions 260, and a memory 265. In some examples, components of the application server 210 (e.g., processor 250, network interface 255, database interface 260, memory 265) may communicate over a system bus (e.g., control busses, address busses, data busses) included in the application server 210. The processor 250, network interface 255, and memory 265 of the application server 210 may include examples of aspects of the processor 230, network interface 235, and memory 240 of the communication device 205 described herein.

For example, the processor 250 may be configured to execute instruction sets stored in memory 265, upon which the processor 250 may enable or perform one or more functions of the application server 210. In some aspects, the processor 250 may utilize data stored in the memory 265 as a neural network. In some examples, the application server 210 may transmit or receive packets to one or more other devices (e.g., a communication device 205, the database 215, another application server 210) via the communication network 220, using the network interface 255. Communications between components (e.g., processor 250, memory 265) of the application server 210 and one or more other devices (e.g., a communication device 205, the database 215) connected to the communication network 220 may, for example, flow through the network interface 255.

In some examples, the database interface instructions 260 (also referred to herein as database interface 260), when executed by the processor 250, may enable the application server 210 to send data to and receive data from the database 215. For example, the database interface instructions 260, when executed by the processor 250, may enable the application server 210 to generate database queries, provide one or more interfaces for system administrators to define database queries, transmit database queries to one or more databases (e.g., database 215), receive responses to database queries, access data associated with the database queries, and format responses received from the databases for processing by other components of the application server 210.

The memory 265 may be configured to store instruction sets, neural networks, and other data structures (e.g., depicted herein) in addition to temporarily storing data for the processor 250 to execute various types of routines or functions. For example, the memory 265 may be configured to store program instructions (instruction sets) that are executable by the processor 250 and provide functionality of the verification engine 266 described herein. One example of data that may be stored in memory 265 for use by components thereof is a data model(s) 267 (also referred to herein as a neural network model) and/or training data 268. The data model(s) 267 and the training data 268 may include examples of aspects of the data model(s) 242 and the training data 243 described with reference to the communication device 205. For example, the application server 210 (e.g., the verification engine 266) may utilize one or more data models 267 for recognizing and processing information obtained from communication devices 205, another application server 210, and the database 215. In some aspects, the application server 210 (e.g., the verification engine 266) may build and/or update one or more data models 267 based on learned information included in the training data 268.

In some aspects, components of the verification engine 266 may be provided in a separate engine in communication with the application server 210.

FIG. 3 illustrates an example of a communications interface 300 that supports intelligent meeting hosting using AI algorithms in accordance with aspects of the present disclosure. The communications interface 300 may be implemented by examples of aspects of a communication device 105 or a communication device 205 described with reference to FIGS. 1 and 2. Example aspects of the communications interface 300 are described with reference to a communication device 205.

The communications interface 300 may be associated with a communications application (e.g., a communications application 244-b implemented at a communication device 205 described with reference to FIG. 2). For example, the communication device 205-a (e.g., using the communications application 244-b) may initiate an online meeting between the communication device 205-a (associated with a User A), the communication device 205-b (associated with a User B), and the communication device 205-c (associated with a User C). In an example, the communications interface 300 illustrates an example interface at the communication device 205-a (associated with the User A) during the online meeting.

The communications interface 300 may include a list 305 of users associated with the online meeting (e.g., User A through User C). The online meeting may include any quantity of users. The users, for example, may be referred to as attendees of the online meeting. The communications interface 300 may include a user representation 310 (associated with User A), a user representation 311 (associated with User B), and a user representation 312 (associated with User C). The user representation 310 through user representation 312 may each include an icon, text (e.g., name, initials), photo image, and/or video image associated with a respective user.

In some aspects, the communications interface 300 may include a set of controls associated with the online meeting. For example, the set of controls may include a button 315 for muting/unmuting audio, a button 320 for starting/stopping video, a button 325 for sharing content (e.g., activating content sharing, selecting content to share), a button 330 for leaving or ending the online meeting, and a button 335 for accessing a chat panel (e.g., for sending text-based messages to one or more users during the online meeting).

In some aspects, the communications interface 300 may be customizable (e.g., based on user preferences, user inputs, etc.). The set of controls described with reference to the communications interface 300 is an example, and any combination of the controls described herein and/or additional controls (e.g., buttons) for accessing functionalities associated with the communications application 244-b may be implemented at a communication device 205. Example aspects of the present disclosure are described herein with reference to the communication devices 205, the application server 210, and the communications interface 300 of FIGS. 2 and 3.

According to example aspects of the present disclosure, a communication device 205 (e.g., communication device 205-a) may support one or more machine learning techniques for automatically and intelligently analyzing input data to verify whether the user intends to share content (e.g., activate content sharing) during an online meeting hosted or supported by the communications application 244-b. The input data may include audio data associated with a user, such as oral statements by the user. In some examples, the input data may include text data corresponding to the oral statements (e.g., text data generated by natural language processing techniques). In some other aspects, the input data may include text-based communications transmitted by the user over the communications application. In some aspects, the input data may include video data associated with the user (e.g., video streamed over the communications application during the online meeting).

The communication device 205 may support machine learning techniques for automatically and intelligently analyzing the input data (e.g., audio data, video data) to verify whether the user intends to enable audio communications during the online meeting. In some other aspects, the communication device 205 may support machine learning techniques for automatically and intelligently analyzing the input data to verify whether the user intends to enable video communications during the online meeting.

For example, the communication device 205-a (e.g., using the communications application 244-b) may initiate an online meeting between the communication device 205-a (associated with a User A), the communication device 205-b (associated with a User B), and the communication device 205-c (associated with a User C). In an example, the communication device 205-a (e.g., in combination with the application server 210) may initiate the online meeting based on a user input at the communication device 205-a. In some aspects, the communication device 205-a may initiate the online meeting automatically (e.g., based on a schedule). In an example, the communication device 205-b and communication device 205-c may join the online meeting automatically and/or based on respective user inputs at the communication device 205-b and communication device 205-c.

User A may be a presenter, for example, intending to discuss and present content (e.g., give a presentation) to User B and User C. In some aspects, the communication device 205-a may learn and predict, based on input data associated with User A (e.g., audio data, video data, user inputs, etc.), whether User A has intended to activate content sharing for presenting content to User B and User C. For example, during the online meeting, the communication device 205-a may learn and predict whether User A intends to activate content sharing.

In an example, the communication device 205-a may receive (e.g., detect) audio data input by User A (e.g., speech inputs, speech segments associated with the speech inputs) during the online meeting. In some aspects, the communication device 205-a may receive (e.g., detect) audio data in real-time during an online meeting. For example, the communication device 205-a may receive (e.g., detect) audio data at any temporal instance during the online meeting.

In some aspects, the communication device 205-a may analyze the audio data using one or more speech processing and/or natural language processing operations described herein (e.g., linguistic context recognition, word recognition, speech recognition, speech-to-text). In some aspects, the analysis of the audio data may be implemented by a machine learning network (e.g., a machine learning network implemented by the verification engine 241). In an example, based on the analysis, the communication device 205-a may generate text data corresponding to the audio data. In some aspects, the text data may include a text description (e.g., a transcript, a partial transcript, a text summary, etc.) corresponding to the audio data.

The communication device 205-a may extract contextual information associated with the audio data based on the analysis. For example, the communication device 205-a may extract contextual information associated with the generated text data (or content included in the generated text data). In an example, the communication device 205-a (e.g., the verification engine 241 and/or the processor 230) may perform syntactic analysis (e.g., parse, analyze sentence structure, etc.). In some aspects of syntactic analysis, the communication device 205-a may parse one or more portions of the text data.

In some examples, the communication device 205-a may perform semantic analysis on the text data or a portion thereof. For example, based on a result of the syntactic analysis, the communication device 205-a may apply semantic analysis to determine contextual information (e.g., semantics information) associated with the text data. In some aspects, the extraction of the contextual information may be implemented by a machine learning network (e.g., a machine learning network implemented by the verification engine 241).

Alternatively, or additionally, the communication device 205-a may provide the audio data to the application server 210, and the application server 210 may analyze the audio data as described herein. For example, the analysis of the audio data may be performed by a machine learning network implemented by the verification engine 266. In an example, based on the analysis, the application server 210 may generate text data corresponding to the audio data.

The machine learning network (e.g., a machine learning network implemented by the verification engine 241, the verification engine 266) may generate an output based on an analysis of the contextual information (or portion thereof). The output may include a prediction of whether User A has intended to share content during the online meeting. In some aspects, the output may include a prediction of whether User A has intended to enable audio communications (e.g., unmute communications associated with User A) during the online meeting. In some other aspects, the output may include a prediction of whether User A has intended to enable video communications during the online meeting.

In another example, the communication device 205-a may receive (e.g., detect) video data (e.g., recorded or streamed video) input at the communication device 205-a and/or the communications application 244-b during the online meeting. In some aspects, the communication device 205-a may receive (e.g., detect) video data in real-time during an online meeting. For example, the communication device 205-a may receive, detect, or capture video data any temporal instance during the online meeting. In some aspects, the communication device 205-a may receive, detect, or capture video data using an image sensor or camera device that is integrated with or electrically coupled to the communication device 205-a.

In some aspects, the communication device 205-a may analyze the video data using one or more gesture recognition operation operations (e.g., bodily recognition operations, etc.), object recognition operations (e.g., facial recognition operations), and/or object tracking operations described herein (e.g., eye-gaze detection, eye tracking, head movement tracking, etc.). In an example, the analysis of the video data may be implemented by a machine learning network (e.g., a machine learning network implemented by the verification engine 241). In an example, based on the analysis, the communication device 205-a may generate contextual information corresponding to the video data.

In an example, the contextual information may include gesture meanings suggestive of User A actively presenting material. In some examples, the contextual information may include an indication of whether User A is actively looking at a display of the communication device 205-a (e.g., based on eye-tracking related to the display) and/or switching user focus to different parts of the display (e.g., based on eye-tracking related to different portions of a display screen of the communication device 205-a). In some cases, the contextual information may include an indication of whether User A is passively looking at the display or not looking at the display (e.g., based on eye-tracking).

In an example, during the online meeting, content sharing may be inactive at the communication device 205-a. For example, User A may have forgotten to activate content sharing at the communication device 205-a. Alternatively, or additionally, User A may have activated content sharing at the communication device 205-a, but technical issues (e.g., an application error) may have terminated the content sharing such that the content is no longer being shared with attendees (e.g., User B and User C) of the online meeting. In both examples, User A may be unaware that the content is not being displayed.

During the online meeting, the communication device 205-a may detect and analyze input data (e.g., audio data input by User A, video data associated with User A, user activity such as keyboard inputs and/or mouse inputs, etc.) at the communication device 205-a to determine whether User A intends to share content. In some aspects, the communication device 205-a may detect and analyze the input data at any temporal instance during the online meeting. For example, the communication device 205-a may detect and analyze the input data beginning at the start of the online meeting. In another example, the communication device 205-a may detect and analyze the input data in response to a trigger condition (e.g., termination of content sharing).

In an example, the communication device 205-a may detect input data which may indicate that User A intends to share content. For example, the input data from User A may include audio data (or corresponding text data generated by speech processing) such as “As you can see here on slide 4 of the presentation materials . . . ” Based on an analysis of the audio data (e.g., using speech processing, natural language processing, context analysis, and/or content analysis described herein), the machine learning network may predict that User A has intended to share content associated with presentation materials.

In another example, the input data from User A may include video data (e.g., object tracking data, eye-tracking data) indicating that User A is actively looking at a display of the communication device 205-a and/or switching user focus to different parts of the display. Based on an analysis of the video data as described herein, the machine learning network may predict that User A is actively focused on content displayed by the communication device 205-a.

In some other examples, the input data from User A may include user activity (e.g., keyboard inputs, mouse inputs) indicating that User A is actively accessing an application 244-c of the communication device 205-a. For example, the user activity may indicate that User A is actively scrolling through content or controlling the presentation of content (e.g., presentation materials, a document, etc.) associated with the application 244-c. Based on an analysis of the user activity as described herein, the machine learning network may predict that User A is actively focused on the content of the application 244-c.

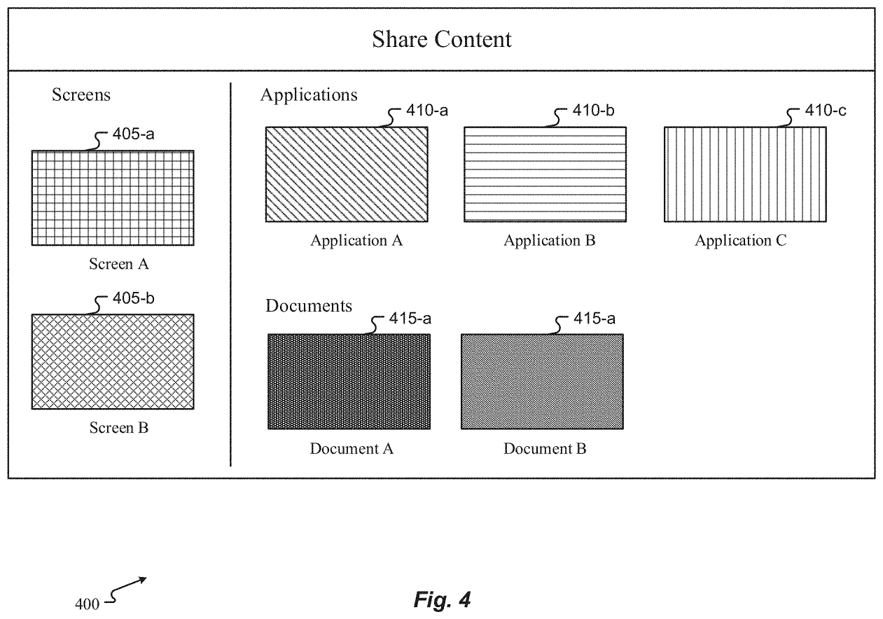

In an example, based on the analysis of the input data, the communication device 205-a may output a notification 326 indicating that content sharing is inactive (e.g., no content is currently being shared). In some cases, the notification 326 may include an inquiry or confirmation request asking whether User A would like to activate content sharing (e.g., enable content sharing). In some cases, based on a user input by User A (e.g., a user input selecting the button 325), the communication device 205-a may provide a user interface for activating content sharing and/or selecting content to share. For example, the communication device 205-a may provide a user interface via which User A may select content and/or the communication device 205-a may suggest content. Example aspects of the content selection and content suggestion are described herein with reference to FIG. 4.

In another example, technical issues (e.g., an application error) may have resulted in the termination of content sharing such that the content is inactive (e.g., no content is currently being shared). Based on the trigger condition (e.g., termination of content sharing), the communication device 205-a may analyze the audio data and predict whether User A intended to terminate content sharing. In an example, based on prediction that User A did not intend to terminate content sharing, the communication device 205-a may output the notification 326. Alternatively, or additionally, based on prediction that User A did intend to terminate content sharing, the communication device 205-a may refrain from outputting the notification 326.

In another example, during the online meeting, audio communications for User A may be disabled (e.g., audio inputs by User A are muted) at the communication device 205-a. During the online meeting, the communication device 205-a may detect input data (e.g., audio data and/or video data) from User A which may indicate that User A is actively speaking.

In an example, the communication device 205-a may detect audio data from User A inclusive of the phrase, “User B, today I will be discussing the presentation materials . . . ” In another example, the communication device 205-a may detect from the audio data that User A is actively presenting materials. For example, the audio data from User A may include phrasing such as “As you can see here on slide 4 of the presentation materials . . . ” In another example, the communication device 205-a may determine, from video data, that User A is actively speaking (e.g., using object tracking applied to mouth movements of User A).

Based on an analysis of the audio data (e.g., using speech processing, natural language processing, context analysis, and/or content analysis described herein) and/or an analysis of the video data (e.g., using object recognition and/or object tracking), the machine learning network may predict that User A has intended to enable audio communications at the communication device 205-a. In an example, the communication device 205-a may output the notification 316 indicating that audio communications are disabled. In some cases, the notification 316 may include an inquiry or confirmation request asking whether User A would like to enable audio communications (e.g., unmute User A).

In other examples, during the online meeting, video communications for User A may be disabled at the communication device 205-a. During the online meeting, the communication device 205-5 may detect audio data from User A which may indicate that User A has intended to enable video communications. For example, the audio data from User A may include the phrase, “I'm glad we have a chance to see each other face-to-face.” In another example, the communication device 205-a may determine, from video data, that User A is actively waving to the camera device of the communication device 205-a (e.g., using gesture recognition and/or object tracking).

Based on an analysis of the audio data (e.g., using speech processing, natural language processing, context analysis, and/or content analysis described herein) and/or the video data, the machine learning network may predict that User A has intended to enable video communications at the communication device 205-a. In an example, the communication device 205-a may output the notification 321 indicating that video communications are disabled. In some cases, the notification 321 may include an inquiry or confirmation request asking whether User A would like to enable video communications.

In some example aspects, the machine learning network (e.g., included in or implemented by the verification engine 241, the verification engine 266, etc.) may support forward learning based on training data. For example, the communication device 205-a may support forward learning based on outputs (e.g., predictions) by the machine learning network. In some examples, the communication device 205-a may support forward learning based on past actions of a user (e.g., User A, User B, User C) with respect to previous predictions by the machine learning network. In some examples, the past actions may include previous activations of content sharing, previous content selections, previous activations of audio communications, previous activations of video communications, and the example actions are not limited thereto. Based on the forward learning, the communication device 205-a may provide increased accuracy.

In examples, the communication device 205-a may support automatically activating content sharing based on the forward learning. In some cases, the communication device 205-a may automatically suggest and/or select content to share based on the forward learning. In some aspects, the communication device 205-a may support automatically activating audio communications and/or video communications based on the forward learning.

In some aspects, the output from the machine learning network may include probability information and/or confidence information. For example, the output from the machine learning network may include probability scores associated with the predictions. In some examples, the output from the machine learning network may include confidence scores corresponding to the probability scores. In an example,

In some aspects, the communication device 205-a may apply visual differences to any portion of the buttons described herein (e.g., button 315, button 320, button 325) and/or any text associated with the buttons. For example, when alerting User A to activate content sharing (e.g., alerting User A that no content is currently being shared), the communication device 205-a may apply visual differences to any portion of the button 325 (e.g., a relatively thicker outline, highlighting, shading) and/or any text associated with the button 325 (e.g., bold italics for “Share”). The visual differences may include, for example, different highlighting, different colors, and/or different font types.

In some other aspects, the communication device 205-a may apply visual differences to any portion of the notifications (e.g., notification 316, notification 321, notification 326) described herein, and the notifications may be of any form. For example, the notification 326 may be an icon, a symbol (e.g., a question mark, an asterisk, an exclamation point), or a shape. In some aspects, the communication device 205-a may output any notification (e.g., notification 326) and/or apply visual differences to any button (e.g., button 325) in real-time during an online meeting.

In some aspects, the notifications (e.g., notification 316, notification 321, notification 326) may be a pop-up notifications displayable on any portion of the user interface 245 (e.g., a display of the communication device 205-a). In an example, the communication device 205-a may output an audible notification and/or haptic notification via the user interface 245 in combination with any of the notifications described herein.

According to example aspects of the present disclosure, the machine learning network (e.g., included in or implemented by the verification engine 241, the verification engine 266, etc.) may calculate probability scores (e.g., from 0.00 to 1.00) associated with the outputs (e.g., predictions) described herein by the machine learning network. In some aspects, the machine learning network may calculate confidence scores (e.g., from 0.00 to 1.00) respectively corresponding to the probability scores.

In an example, the communication device 205-a may output the notifications described herein (e.g., notification 316, notification 321, notification 326) for predictions having a probability score that satisfies (e.g., is greater than or equal to) a probability score threshold and/or a confidence score that satisfies (e.g., is greater than or equal to) a confidence score threshold. Alternatively, or additionally, the communication device 205 may refrain from displaying the notifications for predictions having a probability score that fails to satisfy (e.g., is less than) the probability score threshold and/or a confidence score that fails to satisfy (e.g., is less than) the confidence score threshold.

In some other examples, the communication device 205-a may automatically activate content sharing for predictions having a probability score that satisfies (e.g., is greater than or equal to) the probability score threshold and/or a confidence score that satisfies (e.g., is greater than or equal to) the confidence score threshold. In some cases, the communication device 205-a may automatically suggest and/or select content to share for predictions having probability scores and/or confidence scores that satisfy respective thresholds. In some aspects, the communication device 205-a may automatically activate audio communications and/or video communications for predictions having probability scores and/or confidence scores that satisfy respective thresholds.

FIG. 4 illustrates an example of a user interface 400 that supports intelligent meeting hosting using AI algorithms in accordance with aspects of the present disclosure. The user interface 400 may be implemented by examples of aspects of a communication device 105 or a communication device 205 described with reference to FIGS. 1 and 2. Example aspects of the user interface 400 are described with reference to a communication device 205, an online meeting, and attendees (e.g., User A) of the online meeting.

The user interface 400 may be provided by the communication device 205-a for activating content sharing and/or selecting content to share. In some cases, the communication device 205-a may display the user interface 400 based on a user input associated with sharing content (e.g., a user input selecting the button 325 described with reference to FIG. 3). In some other aspects, the communication device 205-a may display the user interface 400 automatically based on predictions by the machine learning network (e.g., based on probability scores and/or confidence scores associated with the predictions, based on forward learning).

In an example, the user interface 400 may include a set of candidate content to share. For example, the candidate content may include displays 405 of the communication device 205-a, applications 410, and documents 415. The displays may also be referred to herein as monitors, screens, or display screens of the communication device 205-a. In some aspects, the applications 410 may include active (e.g., open) applications and/or inactive applications (e.g., a quantity of previously closed applications, applications closed within a temporal period) at the communication device 205-a. In an example, the applications 410 may include a browser application, a desktop application, a mobile application, or the like. In some examples, the documents 415 may include active (e.g., open) documents and/or inactive documents (e.g., previously closed documents, documents closed within a temporal period).

In some aspects, based on an analysis of input data described herein (e.g., audio data, video data, user activity), the machine learning network may predict whether User A has intended to activate content sharing corresponding to any of the displays 405, applications 410, and documents 415. In some other aspects, the predictions may be based on context analysis and/or content analysis applied by the machine learning network to content associated with any of the applications 410 or documents 415.

In an example, application 410-a may be a presentation application (e.g., a slideshow presentation application), and audio data from User A may include phrasing such as “As you can see here on slide 4 of the presentation materials . . . ” Based on an analysis of the audio data (e.g., using speech processing, natural language processing, context analysis, and/or content analysis described herein), the machine learning network may determine that contextual information associated with the audio data corresponds to a presentation application (e.g., application 410-a). In another example, the communication device 205-a may be displaying multiple applications, including application 410-a. Video data (e.g., object tracking data, eye-tracking data) determined by the communication device 205-a may indicate that User A is actively looking at application 410-a. Based on an analysis of the video data as described herein, the machine learning network may predict that User A is actively focused on application 410-a. In some other examples, the input data from User A may include user activity (e.g., keyboard inputs, mouse inputs) indicating that User A is actively scrolling through content or controlling the presentation of content (e.g., presentation materials, a document, etc.) associated with the application 410-a. Based on an analysis of the user activity as described herein, the machine learning network may predict that User A is actively focused on the content of the application 410-a. Accordingly, for example, based on the input data (e.g., audio data, video data, user activity, or a combination thereof), the machine learning network may predict that User A has intended to share content associated with the application 410-a.

In another example, document 415-a may include content associated with a Topic A (e.g., financial reports), document 415-b may include content associated with a Topic B (e.g., product launch), and the audio data from User A may include phrasing such as “As seen on the graph, this year's financial report . . . ” Based on an analysis of the audio data (e.g., using speech processing, natural language processing, context analysis, and/or content analysis described herein), the machine learning network may determine that content associated with the audio data corresponds to financial reports. Based on an analysis of document 415-a and document 415-b (e.g., using context analysis and/or content analysis), the machine learning network may determine that content associated with the document 415-a corresponds to financial reports. In an example, based on a comparison of the content associated with the audio data (e.g., financial reports) and the content associated with the document 415-a (e.g., financial reports) the machine learning network may predict that User A has intended to share content associated with the document 415-a.

In some aspects, the communication device 205-a may apply visual differences to any portion of the user interface 400 to indicate a candidate (e.g., a display 405, an application 410, a document 410) suggested by the machine learning network. For example, the communication device 205-a may apply visual differences for suggesting the candidates, based on the predictions by the machine learning network. The visual differences may include example aspects of the visual differences described herein (e.g., line thickness, highlighting, shading, font type, colors, etc.).

In an example, based on a user input, the communication device 205-a may share content associated with any of the displays 405, applications 410, or documents 415 during the online meeting. In some aspects, the communication device 205-a may support automatically selecting and sharing content sharing based on forward learning, probability scores, and/or confidence scores described herein.

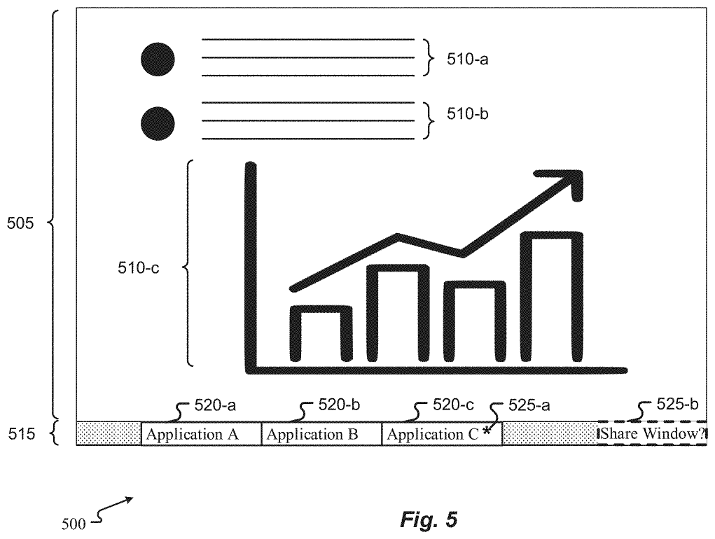

FIG. 5 illustrates an example of a user interface 500 that supports intelligent meeting hosting using AI algorithms in accordance with aspects of the present disclosure. The user interface 500 may be implemented by examples of aspects of a communication device 105 or a communication device 205 described with reference to FIGS. 1 and 2. Example aspects of the user interface 500 are described with reference to a communication device 205, an online meeting, and attendees (e.g., User A through User C) of the online meeting.

The user interface 500 may be associated with an application 520 (e.g., desktop application, mobile application) on a communication device 205-a associated with User A. In the example of the user interface 500, the communication device 205-a may display an application user interface 505 and a taskbar 515. For example, the application user interface 505 illustrated in FIG. 5 may be associated with an application 520-c on the communication device 205-a. The user interface 505, for example, may include content 510 associated with the application 520-c. In an example, content 510-a and content 510-b may include text data, and content 510-c may include numerical and/or visual data (e.g., graph data).

The taskbar 515 may be associated with an operating system of the communication device 205-a. In an example, the taskbar 515 may include indications of active applications 520 on the communication device 205-a. In an example, the active applications 520 may include a browser application 520-a (e.g., Application A), a communications application 520-b (e.g., Application B) associated with the online meeting, and the application 520-c (e.g., Application C), which may be examples of browser application 244-a, communications application 244-b, and application 244-c described with reference to FIG. 2.

In an example, during the online meeting, content sharing may be inactive at the communication device 205-a. For example, User A may have intended to share content associated with application 520-c, but may have forgotten to activate content sharing at the communication device 205-a. Alternatively, or additionally, User A may have activated content sharing at the communication device 205-a, but technical issues (e.g., an application error) may have terminated the content sharing such that the content associated with the application 520-c is no longer being shared with attendees (e.g., User B and User C) of the online meeting. In both examples, User A may be unaware that the content is not being displayed.

In some example aspects, the communication device 205-a may monitor user activity (e.g., keyboard inputs, mouse inputs) in combination with input data (e.g., audio data, video data) associated with User A. In an example, based on the analysis, the communication device 205-a may predict whether User A has intended to share content. For example, the communication device 205-a may detect active user inputs associated with the application 520-c. That is, for example, the communication device 205-a may detect (e.g., based on keyboard inputs and/or mouse inputs) that the presenter is actively viewing or controlling the application 520-c.

Based on an analysis of the active user inputs (with or without an analysis of audio data and/or video data associated with User A), a machine learning network described herein may predict that User A has intended to activate content sharing for the application 520-c. In an example, the communication device 205-a may output one or more notifications 525 (e.g., notification 525-a, notification 525-b) indicating that content sharing is inactive (e.g., no content is currently being shared). In some cases, the notifications 525 may include an inquiry or confirmation request asking whether User A would like to activate content sharing (e.g., enable content sharing).

The notifications 525 may include example aspects of the notification 326 described with reference to FIG. 3. In some aspects, the communication device 205-a may apply visual differences to any portion of the taskbar 515 and/or any text associated with the taskbar 515 (e.g., text associated with any of application 520-a through application 520-c). In some aspects, the communication device 205-a may apply the visual differences to indicate that content sharing is inactive. In some examples, the communication device 205-a may apply the visual differences to indicate a suggested application (e.g., application 520-c) for content sharing.

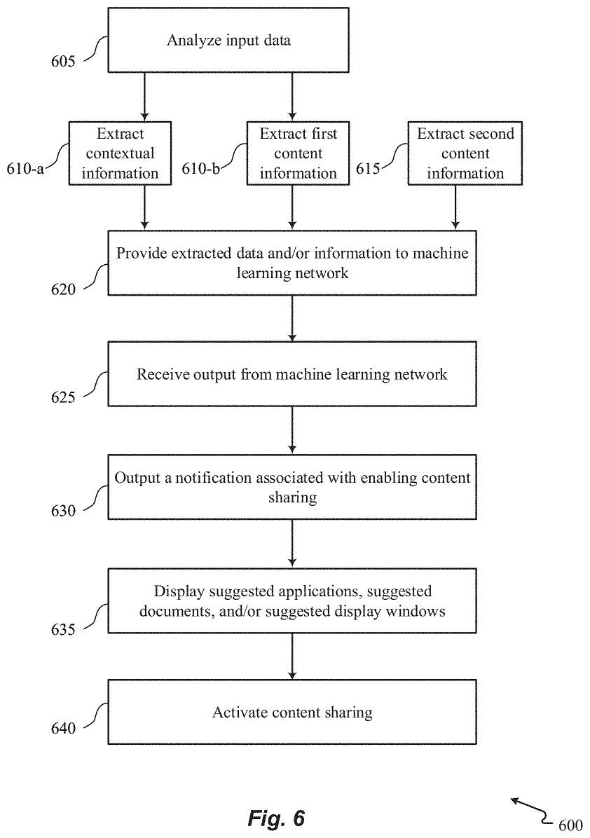

FIG. 6 illustrates an example of a process flow 600 that supports intelligent meeting hosting using AI algorithms in accordance with aspects of the present disclosure. In some examples, process flow 600 may implement aspects of a communication device 105, an application server 110, a communication device 205, an application server 210, a communications application 300, a user interface 400, or a user interface 500 described with reference to FIGS. 1 through 5.

In the following description of the process flow 600, the operations may be performed in a different order than the order shown, or the operations may be performed in different orders or at different times. Certain operations may also be left out of the process flow 600, or other operations may be added to the process flow 600. It is to be understood that while the communication device 105 is described as performing a number of the operations of process flow 600, any device (e.g., another communication device 105, a combination of a communication device 105 and an application server 110) may perform the operations shown.

At 605, a communication device 105 may analyze input data received at the communication device 105. In some aspects, the input data may include audio data, and analyzing the input data may include applying one or more speech processing operations, one or more natural language processing operations, or both to the audio data. In some other aspects, the input data may include video data, and analyzing the input data may include applying one or more gesture recognition operations, one or more object tracking operations, or both to the video data.

In some aspects not illustrated in the process flow 600, the communication device 105 may detect a termination of content sharing at the communication device 105 (e.g., due to technical issues such as an application error). In an example, analyzing the input data at 605 may be based on detecting the termination.

The communication device 105 may extract data or information associated with the input data based on the analyzing. For example, at 610-a, the communication device 105 may extract contextual information associated with the input data based on the analyzing. In another example, at 610-b, the communication device 105 may extract first content information associated with the input data based on the analyzing.

In some aspects, at 615, the communication device 105 may extract second content information associated with at least one active application of a set of active applications, at least one active document of a set of active documents, at least one document of a set of documents accessed within a temporal period, at least one active window of a set of active windows, or a combination thereof.

At 620, the communication device 105 may provide at least a portion of the extracted data or information to a machine learning network. For example, the communication device 105 may provide at least a portion of the contextual information to the machine learning network. In some aspects, the communication device 105 may provide at least a portion of the first content information to the machine learning network. In some examples, the communication device 105 may provide at least a portion of the second content information to the machine learning network.

At 625, the communication device 105 may receive an output from the machine learning network in response to the machine learning network processing at least the portion of the contextual information. In some aspects, the output may include a probability score associated with a determination made by the machine learning network with respect to sharing content associated with the input data. In some aspects, the output from the machine learning network may include a confidence score associated with the probability score.

In some aspects, the output from the machine learning network may include a comparison result of the first content information (e.g., associated with the input data, such as content associated with audio data) and the second content information (e.g., associated with an active application, an active document, and/or an active window).

At 630, the communication device 105 may output a notification associated with enabling content sharing based on the output from the machine learning network. In some aspects, the notification may be associated with enabling audio communications, enabling video communications, or both. In some examples, the communication device 105 may output the notification based on the probability score satisfying a probability threshold, the confidence score satisfying a confidence threshold, or both.

At 635, the communication device 105 may display one or more suggested applications, one or more suggested documents, one or more suggested display windows, or a combination thereof. In some aspects, the communication device 105 may display suggested applications, suggested documents, and/or suggested display windows based on the output from the machine learning network (e.g., autonomously based on a probability score and/or confidence score being greater than or equal to a corresponding threshold).

In some aspects, the communication device 105 may display suggested applications, suggested documents, and/or suggested display windows based on an input associated with enabling the content sharing (e.g., based on an input associated with the notification output at 630), such as a user confirmation and/or a user selection of content.

In some aspects, the communication device 105 may display the one or more suggested applications, the one or more suggested documents, and/or the one or more suggested display windows based on content information associated with the one or more suggested applications, the one or more suggested documents, and/or the one or more suggested display windows. In some aspects, the one or more suggested applications may include at least one active application of a set of active applications at the communication device 105. In some examples, the one or more suggested documents may include at least one active document of a set of active documents at the communication device 105, at least one document of a set of documents accessed at the communication device 105 within a temporal period, or both. In some aspects, the one or more suggested display windows may include at least one active window of a set of active windows at the communication device 105.

At 640, the communication device 105 may activate content sharing. In some aspects, the communication device 105 may activate content sharing based on the output from the machine learning network (e.g., autonomously based on a probability score and/or confidence score being greater than or equal to a corresponding threshold). In some aspects, the communication device 105 may activate content sharing based on an input associated with enabling the content sharing (e.g., based on an input selecting an application, document, or display window displayed at 635), such as a user confirmation and/or a user selection.

In some aspects not illustrated in the example process flow 600, the communication device 105 may detect one or more user inputs (e.g., mouse movements, mouse clicks, keystrokes) associated with an active application on the communication device 105, an active document on the communication device 105, an active window of the communication device 105, or a combination thereof. In an example, analyzing the input data at 605, extracting the contextual information at 610-a, providing at least the portion of the contextual information to the machine learning network at 620, or a combination thereof may be based on detecting the one or more user inputs.

In some aspects not illustrated in example process flow 600, the communication device 105 (or system 100, or server 110) may train the machine learning network based on training data. The training data may include: a user input corresponding to the notification; one or more previous outputs by the machine learning network; one or more user inputs corresponding to least one previous notification associated with enabling the content sharing; or a combination thereof. In an example, the output provided by the machine learning network at 625 may be based on the training.

In some aspects, the methods, devices, and systems described herein may be applied to communications application clients, instant messaging clients, and social media platforms (e.g., any client or platform supportive of content sharing with respect to a virtual meeting environment or a communications environment).

Artificial intelligence, including the utilization of machine learning, can be used in various aspects disclosed herein. For example, as discussed, various levels of content can be analyzed and classified, and this can be configurable by artificial intelligence and/or by user preference. Artificial intelligence, as used herein, includes machine learning. Artificial intelligence and/or user preference can configure information that is used to analyze content and identify relationships between content. For example, artificial intelligence and/or user preference can determine which information is compared to content in order to analyze the content. Artificial intelligence and/or user preference may also be used to configure user profile(s), which may be used to determine relevance to a user (e.g., the user associated with the user profile), a communication (e.g., message, audio communications, video communications), and/or an application by comparing the content to information contained within the user profile.

Some embodiments utilize natural language processing in the methods and systems disclosed herein. For example, machine learning models can be trained to learn what information is relevant to a user or different users. Machine learning models can have access to resources on a network and access to additional tools to perform the systems and methods disclosed herein.

In certain embodiments, data mining and machine learning tools and techniques will discover information used to determine content and/or contextual information. For example, data mining and machine learning tools and techniques will discover user information, user preferences, relevance of content, levels of relevance, contextual information, key word(s) and/or phrases, thresholds, comparison(s) to threshold(s), configuration(s) of content organization of content, and configuration(s) of a user interface, among other embodiments, to provide improved content analysis and/or contextual analysis.

Machine learning may manage one or more types of information (e.g., user profile information, communication information, etc.), types of content (including portions of content within communication information), comparisons of information, levels of relevance, and organization (including formatting of content). Machine learning may utilize all different types of information. The information can include various types of visual information, documents (including markup languages like Hypertext Markup Language (HTML)), and audio information (e.g., using natural language processing). Inputs and outputs, as described herein, may be managed by machine learning. Machine learning may determine variables associated with information, and compare information (including variables within the information) with thresholds to determine relevance. The relevance may determine content organization based on rules associated with the relevance. Machine learning may manage properties (including formatting, hiding and/or reorganizing) and configurations of the organized content. Any of the information and/or outputs may be modified and act as feedback to the system.

In some aspects, methods and systems disclosed herein use information to analyze content and contextual information. Relevance, and variations thereof, can refer to a determination of how closely a piece of information relates to another piece of information. For example, information may be information that is related to a user, and includes and is not limited to user profile information, association with groups, and information from interactions of the user. Information that is related to a user may be obtained from groups or entities associated with the user. Artificial intelligence and/or user preferences may determine the information that is relevant to a user. For example, artificial intelligence and/or user preference may determine what information is relevant (e.g., appropriate, inappropriate, related) to one or more users, communications, messaging windows, messaging applications, social media applications, etc. Artificial intelligence may use the information to build a profile associated with one or more users, where the profile defines what information (or variables within the information) is relevant to the user, previous communications with the user, current communications generated by the user, and other properties of the relevance (e.g., type of relevance (importance, priority, rank, etc.), level of relevance, etc.). Artificial intelligence and/or user preference may use the profile to compare information with content of a communication to determine relevance between the content (including any differences in relevance of various portions of the content), contacts indicated in the communication, contacts of a user generating the communication, messaging windows associated with the communication, messaging applications associated with the communication, and/or social media applications associated with the communication. Relevance of information is used in various embodiments herein to determine rules for how the content may be extracted and/or analyzed for contextual information.

Relevance, as described herein, includes determining how closely related information is. The determination may be by comparison, and may use any criteria, such as thresholds and/or one or more key words. The information may be content within a communication, where a communication can contain one or more pieces (also referred to herein as portions, sections, or items) of content, and may include content that ranges from being not related at all (e.g., not relevant) to content that is directly related (e.g., highly relevant) to contacts indicated in the communication, contacts of a user generating the communication, messaging windows associated with the communication, messaging applications associated with the communication, and/or social media applications associated with the communication. Portions of content may also be referred to herein as simply “content.” There may be two levels of relevance (e.g., relevant and not relevant), or any number of levels of relevance. Any information may be compared to determine relevance. In various embodiments, user information may be used to determine relevance. The user information may include profile information, such as one or more user profiles, that is compared to content. Various types of relevance may be determined for one or more pieces of information, including relevance, priority, importance, precedence, weight, rank, etc. For example, relevance may determine how related content is to a user, contacts indicated in the communication, contacts of a user generating the communication, messaging windows associated with the communication, messaging applications associated with the communication, and/or social media applications associated with the communication, while priority ranks how important the content is. In various embodiments, priority may be based on how relevant a piece of content is. Any combination of one or more types of relevance may be configured and used. For example, content may have high relevance with a low priority and a low rank, content may have high relevance with a high importance and high rank, content may have low relevance with a high importance and a low priority, etc. Content may have any combinations of types of relevance.

As used herein, information includes communications, messages, electronic records, content, visual content including text and images, audio content, rich media, data, and/or data structures. Communications include emails, messages, documents, files, etc. Information includes content, and communications include content (also referred to herein as data). Content may be one type or multiple types (e.g., text, images, hyperlinks, etc.) and there may be multiple pieces of content within a communication or a piece of information, regardless of content type. Content may contain one or more variables. Communications may be data that is stored on a storage/memory device, and/or transmitted from one communication device to another communication device via a communication network.

Communications include multimedia communications (e.g., audio communications, video communications, messages). Audio, video, and/or messages may be transmitted via one or more data packets. The formatting of such data packets may be based on the communication protocol used for transmitting the data packets over the communication network.

Information related to communications may be referred to herein as communication information, communication data, or communication content, and variations of these terms. Communication information can include any type of data related to communications of a user and/or entity (e.g., information being sent to user(s), received from user(s), created by user(s), accessed by user(s), viewed by user(s), etc.). Content of a communication can include information associated with the communication as well as information contained within the communication. Content of a communication may include information not only that is sent and received, but also other information such as information that a user does not necessarily send or receive. Content of communications may be classified in various ways, such as by a timing of the content, items the content is related to, users the content is related to, key words or other data within fields of the communication (e.g., to field, from field, subject, body, etc.), among other ways of classifying the content. The content may be analyzed based on information associated with the content and/or variable(s), including the location of the content and/or variables as it relates to the communication (e.g., a field, sender, recipient, title, or body location within the communication).

As used herein, a data model may correspond to a data set that is usable in an artificial neural network and that has been trained by one or more data sets that describe communications between two or more entities. The data model may be stored as a model data file or any other data structure that is usable within a neural network or an artificial intelligence system.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very large-scale integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively, or additionally, methods described or claimed herein can be performed using artificial intelligence, machine learning, neural networks, or the like. In other words, a system is contemplated to include finite instruction sets and/or artificial intelligence-based models/neural networks to perform some or all of the steps described herein.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method comprising:
analyzing input data received at a device;
extracting contextual information associated with the input data based at least in part on the analyzing;
providing at least a portion of the contextual information to a machine learning network;
receiving an output from the machine learning network in response to the machine learning network processing at least the portion of the contextual information, the output comprising a probability score associated with a determination made by the machine learning network with respect to sharing content associated with the input data; and
outputting a notification associated with enabling content sharing based at least in part on the output from the machine learning network.

2. The method of claim 1, wherein the input data comprises audio data, and analyzing the input data comprises applying one or more speech processing operations, one or more natural language processing operations, or both to the audio data.

3. The method of claim 1, wherein the input data comprises video data, and analyzing the input data comprises applying one or more gesture recognition operations, one or more object tracking operations, or both to the video data.

4. The method of claim 1, further comprising:
detecting a termination of the content sharing at the device,
wherein analyzing the input data is based at least in part on detecting the termination.

5. The method of claim 1, wherein the notification is associated with enabling audio communications, enabling video communications, or both.

6. The method of claim 1, further comprising:
displaying one or more suggested applications, one or more suggested documents, one or more suggested display windows, or a combination thereof based at least in part on the output from the machine learning network, an input associated with enabling the content sharing, or both.

7. The method of claim 6, wherein displaying the one or more suggested applications, the one or more suggested documents, the one or more suggested display windows, or the combination thereof is based at least in part on content information associated with the one or more suggested applications, the one or more suggested documents, the one or more suggested display windows, or the combination thereof.

8. The method of claim 6, wherein:
the one or more suggested applications comprises at least one active application of a set of active applications;
the one or more suggested documents comprises at least one active document of a set of active documents, at least one document of a set of documents accessed within a temporal period, or both; and
the one or more suggested display windows comprises at least one active window of a set of active windows.

9. The method of claim 1, further comprising:
extracting first content information associated with the input data based at least in part on the analyzing; and
providing at least a portion of the first content information to the machine learning network.

10. The method of claim 9, further comprising:
extracting second content information associated with at least one active application of a set of active applications, at least one active document of a set of active documents, at least one document of a set of documents accessed within a temporal period, at least one active window of a set of active windows, or a combination thereof; and
providing at least a portion of the second content information to the machine learning network,
wherein the output from the machine learning network comprises a comparison result of the first content information and the second content information.

11. The method of claim 1, further comprising:
detecting one or more user inputs associated with an active application on the device, an active document on the device, an active window of the device, or a combination thereof,
wherein analyzing the input data, extracting the contextual information, providing at least the portion of the contextual information to the machine learning network, or a combination thereof is based at least in part on detecting the one or more user inputs.

12. The method of claim 1, wherein:
the output from the machine learning network comprises a confidence score associated with the probability score; and
outputting the notification is based at least in part on the probability score satisfying a probability threshold, the confidence score satisfying a confidence threshold, or both.

13. The method of claim 1, further comprising:
training the machine learning network based at least in part on training data, the training data comprising:
a user input corresponding to the notification;
one or more previous outputs by the machine learning network;
one or more user inputs corresponding to least one previous notification associated with enabling the content sharing;
or a combination thereof.
wherein the output provided by the machine learning network is based at least in part on the training.

14. A device comprising:
a processor; and
a memory in electronic communication with the processor, wherein the memory stores data that, when executed by the processor, enables the processor to:
analyze input data received at the device;
extract contextual information associated with the input data based at least in part on the analyzing;
provide at least a portion of the contextual information to a machine learning network;
receive an output from the machine learning network in response to the machine learning network processing at least the portion of the contextual information, the output comprising a probability score associated with a determination made by the machine learning network with respect to sharing content associated with the input data; and
output a notification associated with enabling content sharing based at least in part on the output from the machine learning network.

15. The device of claim 15, wherein the input data comprises audio data, and analyzing the input data comprises applying one or more speech processing operations, one or more natural language processing operations, or both to the audio data.

16. The device of claim 15, wherein the input data comprises video data, and analyzing the input data comprises applying one or more gesture recognition operations, one or more object tracking operations, or both to the video data.

17. The device of claim 15, wherein the data, when executed by the processor, further enables the processor to:
detect a termination of the content sharing at the device,
wherein analyzing the input data is based at least in part on detecting the termination.

18. The device of claim 15, wherein the notification is associated with enabling audio communications, enabling video communications, or both.

19. A system comprising:
a machine learning network;
a device comprising:
a processor; and
a memory in electronic communication with the processor, wherein the memory stores data that, when executed by the processor, enables the processor to:
analyze input data received at the device;
extract contextual information associated with the input data based at least in part on the analyzing;
provide at least a portion of the contextual information to the machine learning network;
receive an output from the machine learning network in response to the machine learning network processing at least the portion of the contextual information, the output comprising a probability score associated with a determination made by the machine learning network with respect to sharing content associated with the input data; and
output a notification associated with enabling content sharing based at least in part on the output from the machine learning network.

20. The method of claim 19, wherein the input data comprises audio data, and analyzing the input data comprises applying one or more speech processing operations, one or more natural language processing operations, or both to the audio data.
